(19) United States
(12) Patent Application Publication
(10) Pub. No.: US 2005/0211032 A1
(43) Pub. Date: Sep. 29, 2005

(54) Cutting technology for metal sheet

(75) Inventor: Zhi-Da Liu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/070,039

(22) Filed: Mar. 2, 2005

(30) Foreign Application Priority Data
Mar. 26, 2004 (CN) 200410026673.0

(51) Int. Cl. B26D 1/00

(52) U.S. Cl. 83/13

(57) ABSTRACT

A cutting technology is disclosed for cutting a metal sheet to achieve a cutting face with high accuracy. The original cutting face has a collapse edge. The cutting technology comprises one rough blanking and one or more fine blankings. The rough blanking eliminates most of the collapse edge. In one fine blanking, cutting clearance per side is 0.5% T or less, T is thickness of the sheet. Holding pressure of the fine blanking is in the range from 10 Mpa to 30 Mpa. If processing more than one blanking, sum of chipping allowances per side is equal to or greater than a width of the left collapse edge. An upper die used in the fine blanking forms an inner cutting blade, the inner cutting blade defines an inner cutting angle “θ” measured from a bottom surface of the upper die, and a curved cutout tangential to the inner cutting blade.

### BACKGROUND OF THE INVENTION

1. Field of the Invention

The present invention relates to cutting technology for metal sheet, and more particularly to metal sheet cutting technology which uses common cutting principle to obtain a high quality cutting face.

2. Prior Art

Referring to FIG. 1, when using conventional cutting die to punch holes or cut marginal portions for a workpiece such as a metal sheet, cutting face of the metal sheet is generally composed of collapse edge 1, burnish 2, tear band 3, and burr side 4. The amount of the burnish 2 determines the quality of the cutting face.

Referring to FIGS. 1-4, a conventional cutting mould includes an upper die 5, a lower die 6, and a pressing pad 7. Factors that affect the quality of a cutting face of a metal sheet 8 includes: cutting clearance between the upper die 5 and the lower die 6, chipping allowance, holding pressure given by the pressing pad 7, and structure of the cutting blade 51. If cutting clearance is too small, a secondary shearing will occur during the upper die 5 being pushed downwardly. Tear band will be left in the middle of the cutting face, and elongated burr side will occur. If cutting clearance is too great, drawing stress increases, the sheet 8 is prone to be tear so that the burnish of the cutting face decreases and the collapse edge increases. If chipping allowance is too great, the sheet will suffer a relative large drawing stress, the cutting blade 51 of the upper die 5 is prone to be worn out, a bottom portion of the cutting face of the sheet 8 will have a small quantity of tear band. If chipping allowance is too small, tear band left during rough blanking will not be eliminated, thus “spots” occur in the cutting face. In general cutting technology, cutting blade 51 is a flat plane, chips 9 will accumulate gradually in the course of cutting, so that the tear band and burr side will occur in the bottom portion of the cutting face. Holding pressure will affect quality of the cutting face as well. Referring to FIG. 3, the holding pressure is too small so that the sheet 8 is horizontally moved by the drawing stress, thus a collapse edge occurs. Referring to FIG. 4, if the holding pressure is too great, the cutting face of the sheet 8 will be bulgily deformed. After finishing cutting and the pressure being released, the sheet 8 will shrink so that size and profile of the sheet 8 will be changed.

In using conventional cutting technology, the burnish 2 of the cutting face of the sheet 8 only occupies about 40% of the whole cutting face. Surface roughness Ra of the sheet is 12.5˜6.3. It does not meet the requirement when sheets with high quality cutting faces are needed. In order to obtain sheets with high quality cutting faces, expansive equipments are usually adopted. This increases manufacturing cost greatly. Another solution is to machine the cutting face of the sheet via numerical control machine. However, the numerical control machine is expansive as well. In addition, it machines the sheets one by one, thereby can not meet the mass production requirement.

To overcome the shortcomings of the above-mentioned manufacturing mode, an improved cutting technology without using special equipments is needed.

### SUMMARY OF THE INVENTION

Accordingly, an object of the present invention is to provide a cutting technology to obtain cutting faces with high accuracy via general cutting mode.

To achieve the above object, cutting technology in accordance with the present invention is disclosed for cutting a metal sheet to achieve a cutting face with high accuracy. The cutting technology comprises one rough blanking, and one or more fine blankings. The rough blanking eliminates most of the collapse edge. In one fine blanking, cutting clearance per side is 0.5% T or less, T is thickness of the sheet. Holding pressure of the fine blanking is in the range from 10 Mpa to 30 Mpa. If processing more than one fine blanking, sum of chipping allowances per side is equal to or greater than a width of the left collapse edge. An upper die used in the fine blanking forms an inner cutting blade, the inner cutting blade defines an inner cutting angle “θ” measured from a bottom surface of the upper die, and a curved cutout tangential to the inner cutting blade.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic cross section showing a cutting face of a metal sheet obtained via conventional cutting technology;

FIG. 2 is a schematic cross section showing profile of a punch blade of an upper die in conventional cutting technology, and clearance between the upper die and a lower die being too small;

FIG. 3 is a schematic cross section showing status of a metal sheet in a conventional cutting technology when holding pressure is too small, and clearance between the upper die and a lower die is too large;

FIG. 4 is a schematic cross section showing status of a metal sheet in a conventional cutting technology when holding pressure is too great;

FIG. 5 is a schematic cross section showing profile of an inner cutting blade in a cutting technology in accordance with the present invention; and

FIG. 6 is a schematic cross section showing a cutting face obtained by the cutting technology of FIG. 5.

### DETAILED DESCRIPTION OF THE INVENTION

An improved cutting technology in accordance with the preferred embodiment of the present invention is applied to obtain high accuracy cutting face of a metal sheet 16 via selecting appropriate parameters of cutting clearance, chipping allowance, holding pressure and structure of a punch blade. The cutting technology is applicable not only to aluminum sheet or copper sheet, but also to low-carbon steel whose carbon content is less than 0.15%. Thickness of the sheet is in the range from 2 mm to 12 mm.

In order to obtain high degree of finish, and to reduce influences of the cutting clearance, chipping allowance and holding pressure to the quality of the cutting face, a rough blanking is usually applied to get a secondary cutting face before one or more fine blankings are used for getting another secondary cutting face. In the rough blanking, parameters are the same with or close to that of the conventional cutting technology.

Cutting clearance is the most important factor that influences the quality of the cutting face. If cutting clearance per side is 0.5% T (T is thickness of the metal sheet), the tear band of the cutting face is reduced greatly, the burnish occupies 95% of the whole cutting face, and the high accuracy requirement of the cutting face is basically met. If the cutting clearance is 0.33% T, the metal sheet with a height of 3 mm will obtain a burnish of 2.8 mm. When the cutting clearance gets smaller, the more burnish the cutting face will have. Ultimately, the cutting clearance of fine blanking of the present invention is chosen in a range of equal to or less than 0.5% T.

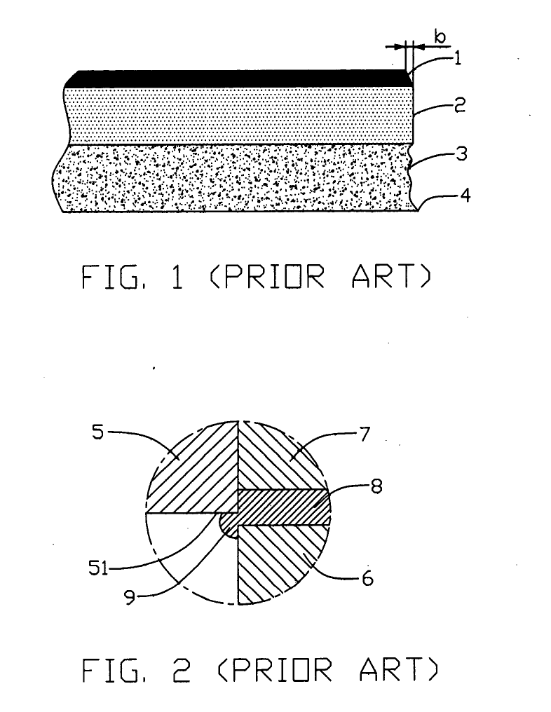

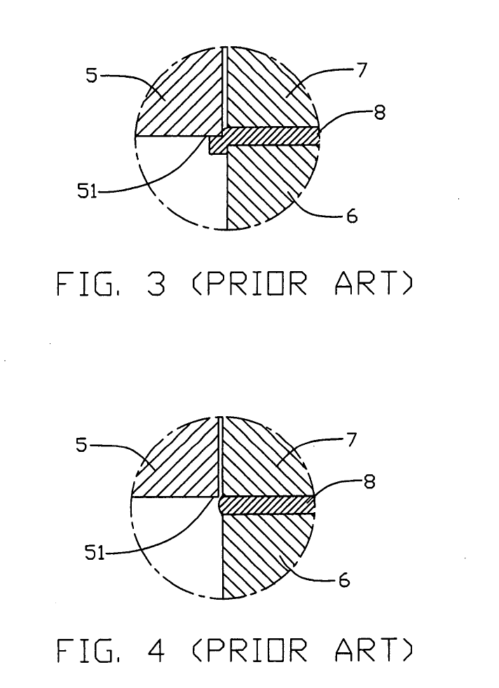

During fine blanking, chipping allowance is also an important factor. In order to increase proportion of the burnish, the collapse edge should be eliminated. The collapse edge left after rough blanking has a width “b” (see FIG. 1), more than one fine blanking is applied to eliminate the collapse edge. The thicker the metal sheet is, the more fine blankings will be needed. With times of the fine blankings increasing, chipping allowance “a” of each fine blanking is reduced gradually (see FIG. 5). The sum of the chipping allowances of the fine blankings is greater than or equal to the width “b” of the collapse edge. The formula is:
b≦a₁+a₂+ . . . aₙ; and a₁>a₂> . . . >aₙ;
wherein “n” means the times of the fine blankings.

Structure of the punching blade is also important to get a high quality cutting face. Referring to FIG. 5, in order to reduce cutting force, chips 12 produced by cutting have to be discharged smoothly. The present invention provides a bulk upper die 10 with an inner cutting blade 14, a bulk lower die 13 and a pressing pad 15. The inner cutting blade 14 defines an inner cutting angle “θ” measured from a bottom surface of the upper die 10, and a curved cutout 11 tangential to the inner cutting blade 14. The chips 12 can be discharged smoothly along the curved cutout 11, thereby preventing chips accumulation. The tear band and burrs are thereby prevented from being formed at the lower portion of the cutting face. More burnish is thus obtained. Choices of the angle “θ” and chipping allowance are related to the quality of the cutting face. Presuming that all surplus left by pre-worksite can eventually be eliminated, the less chipping allowance is, the better quality the cutting face will have. When the metal sheet is thicker so that the chips 12 are getting more, the angle “θ” must be increased to insure a high quality cutting face. However, a too large angle “θ” is not suitable for insuring strength of the blade 14. For instance, when the angle “θ” is 25 degrees or 35 degrees, the chips will be reduced and prevented from accumulating. In the preferred embodiment, the angle “θ” is in the range from 8 degrees to 45 degrees.

To insure accuracy of size and shape of the metal sheet, holding pressure of the pressing pad 15 is a significant factor. In rough blanking, holding pressure can be the same or similar to the conventional cutting technology. In the preferred embodiment, the holding pressure of rough blanking is 10 Mpa, and the holding pressure of fine blanking is in the range from 10 Mpa to 30 Mpa. In this case, movement of the sheet 16 and deformation of the sheet 16 will be avoided.

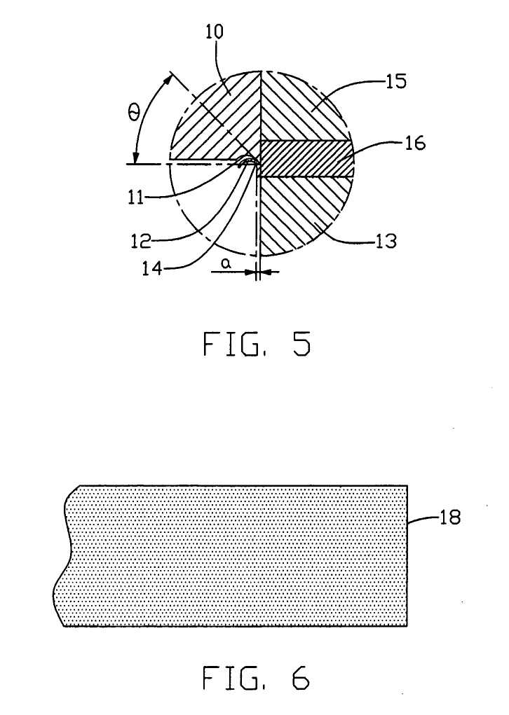

After validating and analyzing the above factors many times via experiments, conclusions are set below: rough blanking firstly, that is, choosing same or similar parameters as the conventional cutting technology, to eliminate most surplus of the sheet; processing fine blankings one by one, via gradually reducing the cutting clearance and chipping allowance, properly increasing holding pressure. A close-to-100% burnish 18 (as shown in FIG. 6) is thus achieved, surface roughness Ra of the cutting face is 0.31. Here are two groups of experiment data:

(a) material: AL5052 H32; thickness: 3 mm

| Technology | Rough Blanking | Fine Blanking |
|---|---|---|
| Clearance Per Side | 1% T | 0.5% T |
| Chipping Allowance Per Side | 6.0 mm | 0.24 mm |
| Blade Angle | — | 25° |
| Holding Pressure | 10 MPa | 25˜30 MPa |

(b) material: AL5052 H32; thickness: 6.5 mm

| | Rough | Fine | Fine | Fine |
|---|---|---|---|---|
| Technology | Blanking | Blanking 1 | Blanking 2 | Blanking 3 |
| Clearance Per | 0.5% T | 0.3% T | 0.3% T | 0.3% T |
| Side | | | | |
| Chipping | 10.0 mm | 2.0 mm | 0.6 mm | 0.3 mm |
| Allowance Per | | | | |
| Side | | | | |
| Blade Angle | — | 35° | 35° | 35° |
| Holding Pressure | 10 MPa | 10 MPa | 25˜30 MPa | ˜25 MPa |

By adopting the above parameters, cutting face of the sheet with nearly 100% burnish is achieved.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A cutting apparatus for cutting a metal sheet to achieve a cutting face with high accuracy, the cutting apparatus comprising:
an upper die with an inner cutting blade, the inner cutting blade defining an inner cutting angle measured from a bottom surface of the upper die, and a curved cutout tangential to the inner cutting blade;
a lower die for supporting the metal sheet; and
a pressing device for applying holding pressure to the metal sheet.

2. The cutting apparatus as claimed in claim 1, wherein the inner cutting angle is in the range from 8 degrees to 45 degrees.

3. The cutting apparatus as claimed in claim 2, processing the sheet with one rough blanking and at least one fine blanking.

4. The cutting apparatus as claimed in claim 3, wherein a clearance between the upper die and the lower die is 0.5% T or less, T is thickness of the sheet.

5. The cutting apparatus as claimed in claim 4, wherein the sheet is aluminum or copper or low-carbon steel whose carbon content is less than 0.15%.

6. The cutting apparatus as claimed in claim 5, wherein thickness of the sheet is in the range from 2 mm to 12 mm.

7. A method for treating a cutting face of metal material to a predetermined requirement, comprising the steps of:
(a) employing a rough blanking on said metal material to create a secondary cutting face by eliminating a portion of said metal material between said cutting face and said secondary cutting face with a length of a first chipping allowance;
(b) employing a fine blanking on said metal material to create another secondary cutting face by further eliminating another portion of said metal material between said secondary cutting face and said another secondary cutting face with a length of a second chipping allowance while said second chipping allowance is significantly smaller than said first chipping allowance; and
(c) repeating said step (b) in order to achieve said predetermined requirement of said cutting face of said metal material.

8. The method as claimed in claim 7, wherein said second chipping allowance of a preceding one of said fine blanking is greater than said second chipping allowance of a subsequent one of said fine blanking.

9. The method as claimed in claim 7, wherein a collapse edge is formed on said cutting face, and a length of said collapse edge equates to or is smaller than a sum of said first chipping allowance and all used ones of said second chipping allowance.

10. The method as claimed in claim 7, wherein in said fine blank step, a cutting clearance between cutting dies to perform said method is equal to or less than 0.5% T, T is a thickness of said metal material.

11. The method as claimed in claim 7, wherein holding pressure for positioning said metal material in said fine blanking step is in the range from 10 Mpa to 30 Mpa.

12. The method as claimed in claim 7, wherein an upper die used in said fine blanking step forms an inner cutting blade, and said inner cutting blade defines an inner cutting angle measured from a bottom surface of said upper die and a curved cutout tangential to said inner cutting blade.

13. The method as claimed in claim 12, wherein said inner cutting angle is in the range from 8 degrees to 45 degrees, and increases in case that said second chipping allowance increases in said fine blanking step.

14. The method as claimed in claim 7, wherein said metal material is one of aluminum, copper and low-carbon steels having a carbon content less than 0.15%.

15. The method as claimed in claim 7, wherein a thickness of said metal material is in the range from 2 mm to 12 mm.

16. The method as claimed in claim 15, wherein performing times of said repeating step increases in case that said thickness of said metal material increases.

17. A method for treating a cutting face of metal material, comprising the steps of:
providing a bulk lower die for placement of said metal material thereon with a portion of said metal material having said cutting face extending out of said lower die;
positioning said metal material by a pressing pad on said bulk lower die;
providing a bulk upper die approachable to said portion of said metal material and said bulk lower die with a blade formed thereon and movable against said lower die to urge separation of said portion of said metal material and the rest of said metal material; and
forming a cutout on said upper die beside said blade so as to allow said portion of said metal material movable into said cutout in case that said blade is moved against said bulk lower die for said separation.

18. The method as claimed in claim 17, wherein an angle measured between a bottom surface of said upper die and a cutout face of said cutout tangential to said blade ranges between 8 degrees and 45 degrees.
